(19) United States
(12) Patent Application Publication
(10) Pub. No.: US 2023/0206234 A1
(43) Pub. Date: Jun. 29, 2023

(54) METHODS AND SYSTEMS FOR SHARED RESOURCE ACCESS

(71) Applicant: Synchrony Bank, Stamford, CT (US)

(72) Inventors: Carolee Coker, Stamford, CT (US); Bengt Horsma, Stamford, CT (US)

(21) Appl. No.: 17/838,886

(22) Filed: Jun. 13, 2022

Related U.S. Application Data
(60) Provisional application No. 63/294,493, filed on Dec. 29, 2021.

(51) Int. Cl. G06Q 20/40; G06Q 20/36

(52) U.S. Cl. CPC G06Q 20/4014; G06Q 20/3674; G06Q 20/363

(57) ABSTRACT

Systems and method are provided for sharing access to a resource. A computing device may receive a request to share access to a resource that includes a user identifier. The computing device may generate a sharetoken that is linked to the resource and provides a limited access credential to access to the resource. The computing device may facilitate transmission of a provisioning link to a device associated with the user identifier. In response to the provisioning link being executed by the device associated with the user identifier, the computing device may transmit the sharetoken. The sharetoken may be stored in an application configured to access the resource using the sharetoken.

### CROSS REFERENCE TO RELATED APPLICATIONS

The present application claims the benefit of U.S. Provisional Patent Application 63/294,493 filed on Dec. 29, 2021, which is hereby incorporated by reference in its entirety for all purposes.

### TECHNICAL FIELD

This disclosure generally relates to a sharing access to a resource; and more specifically to a sharing access to resources secured by remote devices.

### BACKGROUND

Modern devices may access a resource pool (e.g., a quantity of resources) that enable the execution of transactions with operator devices (e.g., proximate and/or remote point-of-sale (POS) devices). The resource pool may be secured by a remote service provider. In some instances, a physical access credentials may be used to facilitate the transaction with an operator device. The physical access credentials may be a primary credentials that has the potential to provide the operator device with unlimited access to the resource. The operator device may define an execute a transaction that uses the physical access credentials to interface with the remote service provider, which causes the remote service provider to transfer a portion of the resource pool requested by the operator device to the operator device. In other instances, a virtual access credential, such as a token, may be stored by a user device. Like the physical access credential, the virtual access credentials may also be a primary credentials that has the potential to provide an operator device with unlimited access to the resource pool. During a transaction, the user device may interface with an operator device by transferring a representation of the virtual access credential. The operator device may then use a representation of the virtual access credentials received from the user device to cause the remote service provider to transfer a requested portion of the resource pool to a service provider of the operator device.

### SUMMARY

Methods and systems are described herein for sharing access to a resource. The methods include: receiving a request to share access to a resource, the request including a user identifier; generating a sharetoken that is linked to the resource, the sharetoken representing a limited access credential; facilitating transmission of a provisioning link to a device associated with the user identifier; receiving, in response to an execution of the provision link, a request for the sharetoken; and transmitting the sharetoken to the device for storage by an application configured to access the resource using the sharetoken.

Systems are described herein for sharing access to a resource. The systems include one or more processors and a non-transitory computer-readable medium storing instructions that, when executed by the one or more processors, cause the one or more processors to perform any of the methods as previously described.

Non-transitory computer-readable media are described herein for storing instructions that, when executed by the one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates an example system in which devices may share access to resources according to aspects of the present disclosure.

FIG. 2A illustrates an example block diagram representing a shared-access provisioning system according to aspects of the present disclosure.

FIG. 2B illustrates an example diagram representing a process for provisioning a device for shared access to a resource according to aspects of the present disclosure.

FIG. 3A illustrates an example block diagram representing a shared-access transaction system according to aspects of the present disclosure.

FIG. 3B illustrates an example diagram representing a process for executing a transaction by a partner device with shared-access to a resource according to aspects of the present disclosure.

FIG. 4 illustrates an example user interface for provision a device for shared-access to a resource according to aspects of the present disclosure.

FIG. 5 illustrates a flowchart of an example process for a primary device provisioning a partner device for shared-access to a resource according to aspects of the present disclosure.

FIG. 6 illustrates a flowchart of an example process for a partner device being provisioned by a primary device for shared-access to a resource according to aspects of the present disclosure.

FIG. 7 illustrates a flowchart of an example process for executing a transaction by a partner device with shared-access to a resource according to aspects of the present disclosure.

FIG. 8 shows a computing system architecture including various components in electrical communication with each other using a connection according to aspects of the present disclosure.

### DETAILED DESCRIPTION

The present disclosure includes systems and methods for implementing shared access to a resource. In some instances, access to a resource secured by a remote device may be facilitated by a physical access credential. The physical access credentials may store data and/or instructions (e.g., via a magnetic, optical, integrated circuits, flash, etc.) that can be conveyed to an operator device (e.g., a POS device, or the like). The data and/or instructions provide access to resources secured by a remote service provider. The operator device may execute a transaction using the data and/or instructions by indicating a quantity of resources, an identification of the operator device, and the data and/or instructions from the physical access credential. The remote service provider authenticates the data and/or instructions, authenticates the operator device as being authorized to execute transactions, determines if the requested quantity of resources are available, and if so, approves the transaction. Since the physical access credentials provides unlimited access to the resource, sharing the physical access credentials would provide the shared user and/or device with unlimited access to the resource as well.

Secure, shared access to a resource can be facilitated with partner devices that are configured for limited access to the resource. A primary device may facilitate the provisioning of one or more partners devices to access a resource (e.g., credit) secured by a service provider. The primary device may be a device associated with a user authorized to access the resource such as the account holder of the resource. During the provisioning process, the primary device may define constraints that, when satisfy, terminate access to the resource. As a result, the primary device facilitates limited access to the resource by the one or more partner devices. A partner device, once provisioned by a primary device to access the resource, can execute transactions in a same or similar manner as the primary device would execute resources (e.g., with operator devices, webservers, etc.). When one or more of the one or more constraints are satisfied (e.g., a predetermined instances of access to the resource have occurred, a threshold quantity of resources have been accessed, and/or the like), resource access may be terminated (e.g., permanently or until the primary device reprovisions the partner device), suspended (e.g., temporarily), or renewed (e.g., if authorized by the primary device).

The primary device may be a primary account holder of a resource. The primary device generating a resource-sharing configuration that includes an identification of a resource to be shared, an identification of a quantity of resources to be shared (e.g., up to the entire resource pool, etc.), an identification of a quantity of instances in which the resource can be accessed once sharing is authorized, an identification of time interval over which the resource can be accessed once sharing is authorized, an identification of the one or more partner devices, combinations thereof, or the like. The primary device then transmits a request for shared access to the resource to a token service platform. The request can include an identification of the primary device (e.g., device identifier, user identifier, account identifier, and/or the like), an access credentials that indicates that the primary device is authorized to access the resource and/or establish sharing of the resource (e.g., the primary device is associated with a user that is the primary account holder of the resource), the resource-sharing configuration, combinations thereof, or the like.

The token service platform may identify the resource to be shared and determine that the primary device is authorized to enable sharing of the resource. The token service platform then generates a sharetoken that enables access to the resource. The token service platform then transmits the sharetoken to an account management platform (e.g., the remote service provider that manages access to the resource, such as a card account management platform, or the like). The account management platform may store the sharetoken in association with the primary account of the resource. The token service platform may then transmit a response to the primary device. The response may include a notification that the sharetoken has been created and a push provisioning link that, once executed, facilitates the provisioning the partner device.

The primary device may transmit a communication to the partner device that includes the push provisioning link. The communication may be transmitted through a notification platform. In some instances, the communication may be a push notification, or the like. The partner device may execute the push provisioning link causing the partner device to transmit a provisioning request to the token service platform, which authenticates the request as coming from the partner device (e.g., a device authorized by the primary device) and transmits a response that includes the sharetoken. The partner device may store the sharetoken for use in executing a transaction. For example, the sharetoken may be stored in a digital wallet of the partner device that stores tokens. Alternatively, or additionally, the sharetoken may be stored in persistent memory of the partner device. When executing a transaction, the partner device may communicate a representation of the sharetoken to an operator device or webserver (e.g., using push notifications, a barcode, a quick-response (QR) code, near-field communication (NFC) integrated circuit, and/or the like). When the transaction terminates, the partner device, account management device, and/or the token service platform may transmit a notification to the primary device with information associated with the transaction.

In some instances, the partner device may request access to the resource from the primary device before or during a transaction. In those instances, the partner device may transmit a transaction request to the primary device. The transaction request may include an identification of the partner device, an identification of an operator and/or webserver with which the transaction is to occur, an identification of a quantity of resource, an identification of when the transaction is to occur, combinations thereof, or the like. The primary device may generate a configuration for sharing access to the resource that includes, but is not limited to, quantity of resources to share, quantity of instances in which the resource can be shared, time interval over which the resource is to be available for sharing, etc. The primary device may then transmit 1) a request to the token service platform to generate a sharetoken for the partner device that includes the configuration 2) a transaction authorization request to the account management platform, and 3) a notification to the partner device that the primary device authorized access to the resource. The account management platform may transmit a communication to resource the authorization platform indicating that the partner device is pre-authorized to access a quantity of resources (e.g., as indicated by the primary device).

The partner device may proceed with the transaction by transmitting a representation of the sharetoken to the operator device or webserver. The representation may include a push notifications, a barcode, a quick-response (QR) code, near-field communication (NFC) integrated circuit, and/or the like. The operator device and/or webserver may execute a transaction for a quantity of resource agreed to by the operator and/or webserver and the partner device. Executing the transaction includes transmitting a request for resources to the authorization platform. If the request is for a quantity of resources that less or equal to the quantity of resources for which the partner device is pre-authorized for, then the transaction is approved. The authorization platform may transmit a notification to the account management platform to transfer the requested resources to a service provider of the operator device and/or webserver (or to the operator device and/or webserver). The account management platform may transmit a notification to the primary device with information associated with the transaction.

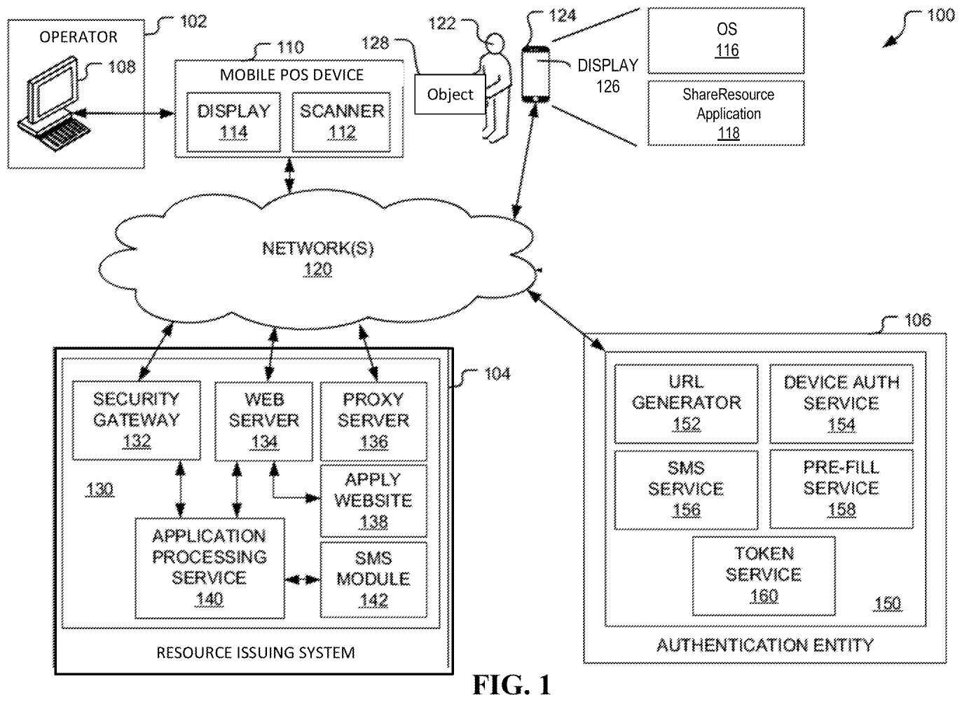

FIG. 1 illustrates an example system in which devices may share access to resources according to aspects of the present disclosure. In example system 100 of FIG. 1, POS device 110 can execute transactions with shared resources as described above. User device 124 (e.g., a mobile computing device such as a smartphone, laptop, personal digital assistant, etc.) may initiate a transaction with operator 102 for the acquisition of item 128 for user 122. User device 122 may include operating system 116 which manages the physical operations (e.g., sensors, transceivers, storage media, etc.) and digital operations (e.g., application such as Share-resource application 118) of user device 116. Share-resource application 118 may be partitioned into a primary application and a partner application. The primary application manages resources for which user device 124 and/or user 122 are primary account holders of a resource. The primary application may be shared with a partner application executing on another device. The partner application may be provisioned to access to a resource managed by a primary application executing on another device. The partner application maybe operated to execute transactions using a resource of a primary application of a remote user device.

The example system 100 includes an operator 102 (e.g., such as a retailer, datastore, etc.), a resource issuing system 104, an authentication entity 106, and/or other platforms, entities, and/or devices configured to facilitate a transaction between user devices (e.g., such as user device 124) and operator devices (e.g., such as operator device 108). In some systems, aspects can be merged, such as for example, authenticating entity 106 being merged with resource issuing system 104 such that devices of authentication entity 106 and resource issuing system 104 can be the same device or devices. Operator 102 can include operator device 108 connected to POS device 110. Though only one POS device 11 is shown, operator device 108 may be connected to one or more POS devices. POS device 110 can include a scanner 112 (e.g., a barcode or QR scanner, near-filed communication reader, and/or other scanner configured to capture information presented or transmitted by user devices) and display device 114. POS device 110 can include various systems for communicating with user device 124. The communication systems can include, but are not limited to, Bluetooth, WiFi, cellular, NFC, or other wireless communication systems. In some examples, rather than communicating using local wireless communications, Share-resource application may initiate a transaction with POS device 110 and/or a webserver using network 120 (e.g., a remote network, the Internet, or the like). In various implementations, the user device 124 can access various communication channels, including short message service (SMS), text, application-based communications, e-mail, web browsers, or other such communication channels.

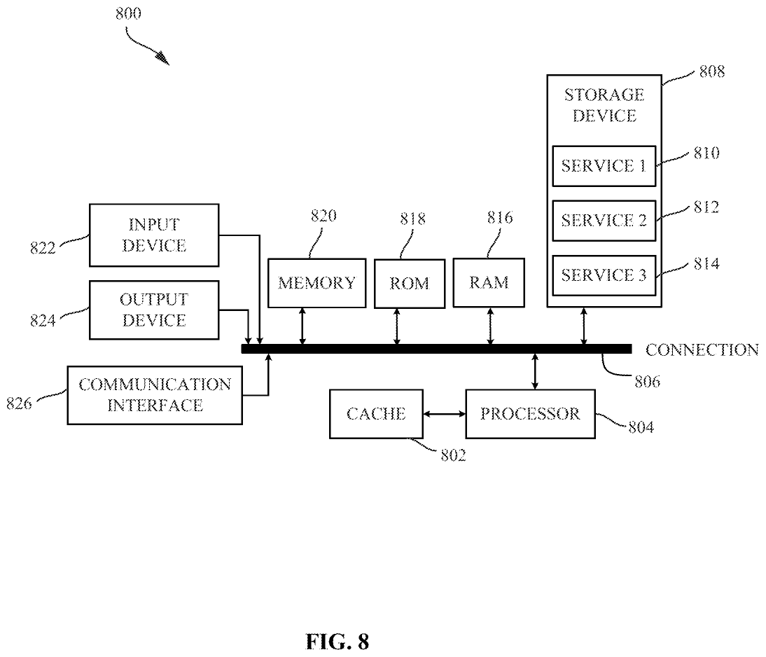

Once a connection is established between POS device 110 and user device 124, a transaction can be initiated using a resource accessible to share-resource application 118 of user device 124 (e.g., a resource that user device 124 is sharing or a resource that user device 124 is the primary device). User device 124 may store a token (if the user device is the primary device) or a sharetoken (if the user device is not the primary device) in the share-resource application 118 and/or a wallet native to the user device 124 (e.g., such as Apple Wallet®, Google Pay®, and/or the like) that may be usable to initiate the transaction. Additionally, other implementations of POS device 110 can include a resource scanner or other payment input, a keypad, or other such elements. Additional examples of a POS device 110 can be a tablet device, a smartphone, a laptop computer, or any other such device that can be accessed by a user, either directly, or through an employee of operator 102. The operator device 108 may be directly connected or connected by network 120 (described below) to POS device 110. The operator device 108 and POS device 110 may each be implemented by one or more computing devices, which may each be implemented as a computing device with architecture 800 described below and illustrated in FIG. 8.

Referring to FIG. 1, POS device 110 may be configured to be operated by a user 122 having a user device 124 with a display device 126 (e.g., a touchscreen, or the like) and/or other input device (e.g., keypad, keyboard, mouse, or the like). For example, user 122 may acquire one or more objects 128 using POS device 110. Mobile services may be provided to user device 124 by a mobile service provider or carrier. The carrier may operate one or more computing devices configured to communicate over network(s) 120. The computing device(s) may each be implemented as the computing device with architecture 800 described below and illustrated in FIG. 8.

Resource issuing system 104 may operate one or more computing devices 130. Computing device(s) 130 may implement security gateway 132, web server 134, proxy server 136, application processing service 140, SMS module 142, account management platform (not shown), token service platform (not shown), and/or other applications, services, and/or servers. Security gateway 132 is configured to communicate with the SCO device 110 over the network(s) 120. The web server 134 and proxy server 136 may be connected to network(s) 120. Web server 134 may be configured to generate an apply website 138 configured to enable user device 124 to request to establish a new resource pool for which user device 124 may be a primary account holder. Application processing service 140 is configured to communicate with the security gateway 132 and/or the web server 134 to provide application services to user device. For example, application processing service may enable share-resource application 118 to communicate and/or synchronize states with other share-resource applications executing on other devices (e.g., such as a primary device with a shareholder device or vice versa). SMS module 142 may be configured to communicate with application processing service 140 to enable application processing service 140 to transmit communication between user device (e.g., such as push notifications, etc.). SMS module 142 may be implemented by operating systems of computing device(s) 130, middleware, and/or the like. In some examples, computing device(s) 130 may be implemented as the computing device architecture 800 described below and illustrated in FIG. 8.

Authentication entity 106 may operate one or more authentication computing devices 150 configured to communicate over network(s) 120. Authentication computing device(s) 150 may implement Uniform Resource Locator (“URL”) generator 152, device authentication service 154, SMS service 156, pre-fill service 158, account management platform (not shown), token service platform 160, and/or other applications, services, and/or servers. In some examples, authentication computing device(s) 150 may each be implemented as the computing device with architecture 800 described below and illustrated in FIG. 8.

Token service 160 can act in a number of ways to facilitate secure communications between user 122 and various other services and devices, including operator computing system 108 and resource issuing system 104. Additionally, token service 160 can tokenize a URL generated for user 122 by URL generator 152 in response to request data received via operator computing system 108. Tokenization is a process of substituting sensitive data elements with non-sensitive equivalents (e.g. tokens). The token is a reference identifier that can be mapped to the sensitive data via token service 160. Such a token service 160 can use large random number in combination with other systems, such as timing systems, to limit and secure the use of sensitive data being communicated over networks such as networks 120.

As described above, in some examples, authentication entity and resource issuing system 104 can, in some implementations, be the same system. In such a system, token service 160 can further act to generate tokens for resource numbers or other aspects of transactions which involve resource issuing system 104 (e.g., such as sharetokens are previously described). In additional examples, other aspects of system 100 can further be altered or include additional or intervening elements, such as multiple users, users with shared accounts, additional merchant or operator systems, subsystems that can operate independently, such as the use of an independent SMS service, or any other such structure for system 100.

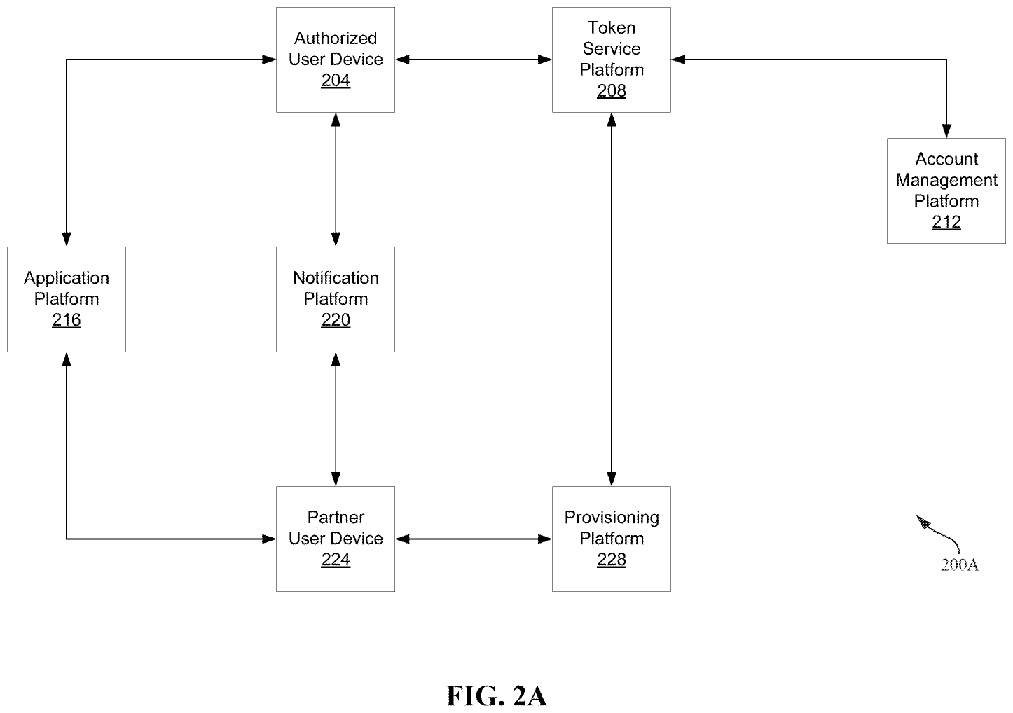

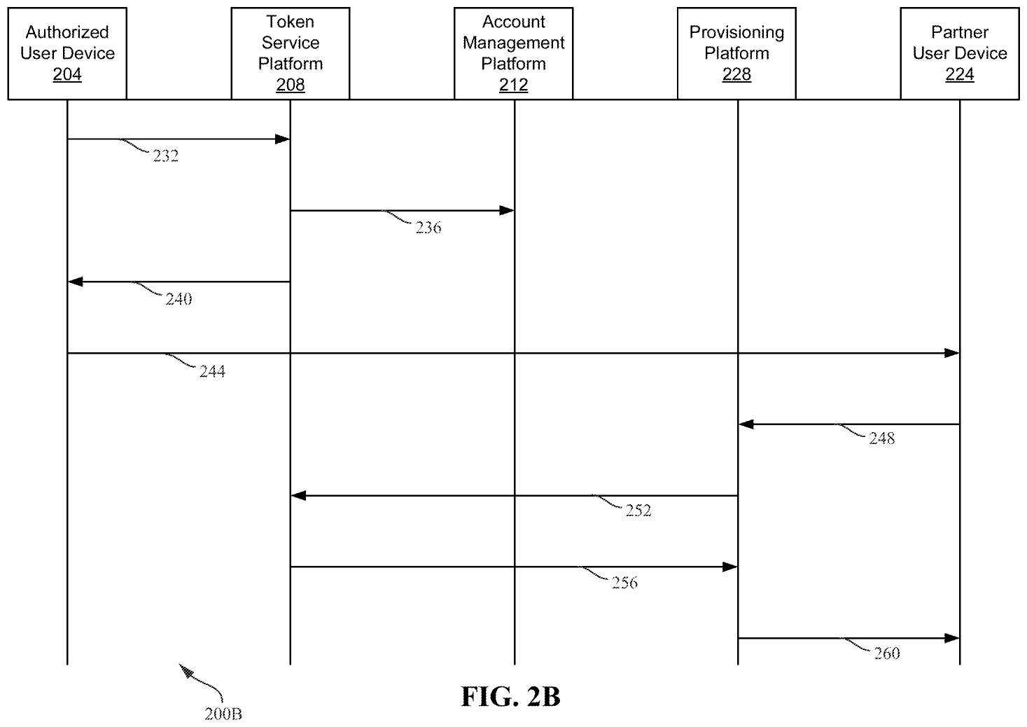

FIG. 2A illustrates an example block diagram representing a shared-access provisioning system according to aspects of the present disclosure. Shared-access provisioning system 200A includes primary user device 204 that facilitates the provisioning of partner user device 224. Primary user device 204 may be a computing device (e.g., mobile device such as a smartphone or the like, laptop or desktop computer, and/or any other processing device) that is authorized to access a resource secured by a service provider (e.g., such as a resource issuing system, account management system 212, and/or the like). For example, primary user device 204 may have applied for a resource pool from the remote service provider. Upon approval of the application, the remote service provider may provide a physical access credentials (e.g., a credit card, RSA key, flash drive (e.g., storing a public and/or private key, secret key, etc.), and/or the like) usable by the primary user device 204 to access the resource pool and initiate a transaction. In some instances, the primary user device 204 may transmit a request to token service platform 208 for a token. The token may abstract the physical access credentials adding an extra layer of security while enable digital access to the resource. For example, the token services platform 208 and/or account management platform 212 may store an association between the token and at least one of the physical access credentials or the resource. Primary user device 204 may initiate transactions with the token without providing the physical access credential, thereby reducing the likelihood that the physical access credentials and/or a portion thereof may be intercepted. Primary user device 204 may store the token in a wallet, in a share application (e.g., such as share-resource application 118 of FIG. 1), or otherwise in persistent (e.g., non-volatile) memory.

As previously described, primary user device 204 may provision partner user device 224 (e.g., mobile device such as a smartphone or the like, laptop or desktop computer, and/or any other processing device) with limited, shared access to the resource using a share-resource application that may execute on primary user device and/or partner user device 224. Partner user device 224 may obtain a sharetoken, which corresponds to, but may be different from, the token stored by primary user device 204. The sharetoken may be used to identify the resource for which partner user device 224 has shared access and/or any constraints on that shared access. For example, the constraints can include, but are not limited to, a quantity of resources that partner user device 224 has access to, a quantity of instances in which the partner user device 224 may access the resource, a time interval over which shared access to the resource is authorized, combinations thereof, or the like. In some instances, the identification of the constraints may be included in the sharetoken. In other instances, the constraints may be identified by querying the account management platform with the sharetoken. Alternatively, or additionally, the constraints may be identified by querying primary user device 204 that established shared access to the resource.

Primary user device 204 may provision partner user device 224 by generating a resource-sharing configuration using the resource-sharing application (e.g., share-resource application 118 of FIG. 1). The resource-sharing configuration may include an identification of the resource, an identification of any constraints on resource sharing, an identification of the user and/or partner user device 224 for which shared-access is to be granted, and/or the like. In some instances, the resource-sharing configuration may also include an access credentials that indicates that primary user device 204 is authorized to access the resource and/or authorized to grant access to other users and/or user devices. Alternatively, the access credentials may be transmitted prior to transmission or use of the resource-sharing configuration. For example, the access credentials may be transmitted during a loading of the share-resource application, when the share-resource application logs in, and/or any time prior to generation or use of the share-resource configuration.

In some instances, primary user device 204 may use machine-learning to generate the resource-sharing configuration. Resource-sharing application may store a record of each instance in which a resource is shared with partner user device 224 and/or other partner user devices (not shown). Resource-sharing application may extract features from each instance that the resource was shared Examples of such features include, but are not limited to, a user identifier of a user with which the resource was shared, a device identifier corresponding to the device and/or user with which the resource was shared, a quantity of resources that were shared, a timestamp indicating when the resources were shared, a time interval over which the resources were shared, a quantity of transactions that were authorized by primary user device, an operator device or user device with which partner user device 224 initiated a transaction using the resource, a webpage or webserver with which partner user device 224 initiated a transaction using the resource, an identification of an operator or user with which partner user device 224 initiated a transaction using the resource, a quantity of resources of the quantity of resources that were authorized for sharing that were accessed by partner user device 224, an identification of an object and/or service acquired subject to a transaction including the resource, a geolocation of authorized user device 204 when the resources were shared, a geolocation of partner device 224 when resource sharing was requested and/or when the resources were shared, demographic information associated with a user of authorized user device 204, demographic information associated with a user of partner user device 224, an identification of users associated with authorized user device 204 (e.g., communication contacts, social media contacts, and/or the like), an identification of users associated with partner user device 224, or the like. Alternatively, the record of each instance in which the resource is shared with partner user device 224 and/or other partner suer device may be stored by another device (e.g., such application platform 216, token services platform 212, or another remote device). Similarly, the features may be extracted by another device (e.g., such application platform 216, token services platform 212, or another remote device).

The extracted features may be used to define a feature vector. The feature vector may be a representation of a set of features in a particular order (e.g., such as time a time interval over which the feature occurred, or the like). The feature vector may be used to train a machine-learning model to generate predictions of future resource-sharing requests. If the feature vector is too small (e.g., insufficient data to train the machine-learning model), then additional resource-sharing requests may be generated (e.g., manually, procedurally, or the like). Features may be extracted from the generated resource-sharing requests and be added to the feature vector.

The machine-learning model may be trained to generate the resource-sharing configuration. The machine-learning model may be a multi-output classifier that generates a predicted value for each constraint available in the resource-sharing configuration (e.g., where constraints that are not used may have a value of zero or null). In some examples, the machine-learning model may be a recurrent neural network, a convolutional neural network, and/or the like using an algorithm such as, but not limited to a regression (e.g., linear, logarithmic, or the like), nearest neighbor, k-means, support vector machine, Naïve Bayes, random forest, or the like.

Once the machine-learning model is trained, the machine-learning model may be used to suggest resource sharing with particular user identifiers, suggest resource sharing with particular partner user devices, and/or generate resource-sharing configurations for a particular resource-sharing request. For example, when authorized user device 204 initiates a new resource-sharing request, the machine-learning model may provide a predicted resource-sharing configuration for the request (e.g., pre-populating the user input fields, or the like). As user input is received populating fields of the resource-sharing configuration, the machine-learning model may be re-executed using the additional user input to refine the predicted resource-sharing configuration (e.g., generating revised predictions for remaining fields of the resource-sharing configuration based in part on previously received user input from other fields). The process may repeat each time new user input (or after a predetermined time interval, when particular user input is received, when a quantity of user input has been received that is greater than a threshold quantity, or the like) is received until user input is received indicating the resource-sharing configuration is approved.

The resource-sharing configuration may be transmitted to token service platform 208. Token service platform 208 may include one or more computing devices (e.g., desktop or laptop computers, mobile devices, servers, networks, other processing devices, combinations thereof, or the like) configured to provide secure services to user devices and account management platform 212. Token service platform 208 may provide secured services to account management platform 212 by generating tokens associated with resources provided by account management platform 212 to users and/or user devices. For example, a user of authorized user device 204 may be issued resources by account management platform 212. The resources may be accessible by a physical-access credential or through an identifier generated by account management platform 212. Account management platform 212 may authorize token service platform 208 to generate tokens that correspond to the resources issued to the user. The tokens may be virtualized representations of the physical-access credential and/or identifier that enable limited access to the resource assigned by account management platform 212.

Token service platform 208 may expose a set of application programming interfaces accessible to account management platform 212, authorized user device 204, other user devices, a share-resource application, etc. Account management platform 212 may access the set of application programming interfaces to define the properties of tokens that token service platform 208 can generate to access resources assigned and/or managed by account management platform 212. Once defined, token service platform 208 may begin generating tokens based on the defined properties upon receiving a request by an authorized user device. In some instances, account management platform 212 may also access the application programming interfaces to terminate tokens, modify the definition of previously defined tokes, modify the definition of tokens that have already been generated by token service platform 212, modify properties of existing tokens, modify particular tokens (e.g., individual, groups, or entire sets of tokens), etc. The application programming interfaces may also enable access to the tokens by other external devices, applications, and/or services. For example, authorized user device 204 may access the application programming interfaces to request the generation of one or more tokens that correspond to a resource of the authorized user device 204 and/or a user thereof.

New tokens may be defined by account management system 212. Account management platform 212 may register with token service platform 208 (and/or other token service platforms) to enable token service platform 208 generate tokens usable to access the resources of the account management platform 212. During registration the account management platform 212 may define properties that may apply to each token generated by token service platform 208 to access the resources of the account management platform 212 (e.g., using the application programming interfaces, or the like). In some instances, the account management platform 212 may define additional properties that apply to those tokens generated for resources assigned to a particular user or group of users. For instance, account management platform 212 may define a first set of properties that apply to tokens that correspond to a first resource assigned to a first user and a second set of properties that apply to tokens that correspond to a second resource assigned to a second user. The first set of properties and the second set of properties may have overlapping properties or may be disjoint sets. In some examples, account management platform 212 may define universal properties that are to apply to all tokens generated for resources assigned or managed by account management platform 212 and/or local properties that apply to tokens associated with a particular resource, set of resources, user, set of users, combinations thereof, or the like.

For example, account management platform 212 may define a property that indicates to token service platform 208 how to generate identifiers (e.g., token IDs) for the tokens generated by token service platform 208. The property may indicate that the tokens usable to access a particular resource are to have token IDs that are within a particular identifier of the resource. The particular identifier of the resource may be an alphanumeric string of a predetermined length (e.g., sixteen characters, etc.) in which a first set of characters of the alphanumeric string identify account management platform 212. The property may indicate that tokens generated by token service platform 208 for the account management platform 212 have a same first set of characters as the particular identifier of the resource. Alternatively, or additionally, the property may indicate that the tokens generated for a particular resource are to be within a predetermined distance from the resource identifier.

The account management platform 212 may also define constraints associated with tokens generated by token service platform 208. The constraints may be applied to all tokens generated by token service platform 208 for resources assigned by the account management platform 212 and/or may be applied to a particular group of tokens (e.g., those tokens that correspond to a particular resource, set of resources, user, set of users, combinations thereof, or the like). The constraints may limit how tokens can be used to access the resource. Examples of constraints include, but are not limited to, a time-to-live (TTL) value indicative of interval over which token can be used once generated, time intervals over which the tokens may be usable (e.g., times of day, days of a week or month, etc.), an identification of operators where tokens may be usable, an identification of operator types where tokens may be usable, an identification of a quantity of resources accessible by a token, an identification of one or more types of use (e.g., hand-keyed, swiped, near-field communication, tap, etc.), an identification of locations in which tokens may be used (e.g., geographical locations, etc.), a quantity of instances in which the token may be used, a quantity of instances in which the token may be used by an operator, a quantity of instances in which the token may be used by an operator type, a quantity of instances in which the token may be used per geolocation, and the like.

In some examples, account management platform 212 may define one or more token types for each resource. Each token type may include a set of properties and constraints that are to apply to those tokens. User devices, share-resource application, other devices, and/or services may request that token service platform generate a token corresponding to a particular token type. In some examples, one token type may generate tokens configured to share access to a resource. For example, upon receiving a request to generate a token from authorized user device 204, token service platform 208 may generate and/or distribute a token to another device (e.g., partner user device 224) to enable the other device to access a resource of a user of authorized user device 204. Account management platform 212 may define token types that specific to a particular resource, set of resources, user, user device, set of users, set of user devices, etc.

Alternatively, or additionally, token service platform 208 may include predefined token types that are exposed to account management platform 212 and/or other account management platforms through the application programming interface. Account management platform 212 define a set of tokens though the application programming interface for a particular resource that includes an identification of one or more of the predefined token types. Account management platform 212 may define tokens that correspond to the predefined token types, modify one or more of the token types, define new token types (as previously described), and/or define particular tokens for all or some of the resources of account management platform 208.

Once defined, token service platform 208 may generate a set of tokens that correspond to the definitions of account management platform 212. The tokens may be distributed to authorized user devices (e.g., such as authorized user device 204) upon an authenticated request. Alternatively, token service platform 208 may wait for an authenticated request from an authorized user device and then generate a token according to the definition. Since the tokens are generated on demand, it may be more difficult for the tokens to be access by unauthorized user or user device. The new token may then be distributed to the authorized user device. Token service platform 208 may also generate sharetokens from tokens of a particular resource. Sharetokens may include an abstracted form of a token configured for use by a user or user device authorized by the user of authorized user device 204. For example, user device 204 may request a sharetoken be generated for a partner user device 224 to enable partner user device 224 to access a portion of the resource of user device 204.

In some instances, the resource-sharing configuration may also include an identification of a token type. Account management platform 212 may define one or more different tokens for authorized user device 204 that may each be enabled to access the resource of authorized user device 204. The one or more different tokens may correspond to one or more predefined token types and/or one or more tokens having particular set of properties and constraints (e.g., distinguishable from other tokens having different properties and/or constraints). Token service platform 208 may assign each unique token (e.g., each token that corresponds to a predefined token type or having a unique priorities and constraints, etc.) an identifier. The authorized user device 204 may include an identification of the token identifier in the resource-sharing configuration. Alternatively, or additionally, token service platform 208 may determine a token identifier that corresponds to the information in the resource-sharing configuration. Token service platform 208 may identify a token identifier that exactly matches the resource-sharing configuration or a token identifier corresponding that best matches the resource-sharing configuration (e.g., a closest match based on a hierarchy of properties and/or constraints, etc.).

Upon receiving the resource-sharing configuration, token service platform 208 may authenticate the sharing request with account management platform 212 (if not already authenticated) using the access credential. Token service platform 208 may then identify an already-generated token or generate a new token that corresponds to the resource-sharing configuration. The token may correspond to a predefined token type and/or have properties and/or constraints as requested by the resource-sharing configuration. For example, token service platform 208 may identify a token that includes one or more properties and/or constraints identified by the resource-sharing configuration. Token service platform 208 may then generate a sharetoken that corresponds to the token. In some examples, the sharetoken may be generated by generating a hash of the token. In other instances, the sharetoken may be generated by a random number generated seeded using the token. In still yet other instances, the sharetoken may be generated by in a similar or same manner as the token. Token service platform 208 may transmit a representation of the sharetoken to account management platform 212.

Account management platform 212 may identify the user account that correspond to the primary user device and/or the resource. Account management platform 212 may include one or more computing devices (e.g., desktop or laptop computers, mobile devices, servers, networks, other processing devices, combinations thereof, or the like) configured to secure access to user accounts that include access to resources. Account management platform 212 may then generate an association between the user account and the sharetoken. When a transaction is executed, account management platform 212 can determine that the token is a sharetoken, identify the user account that correspond to the sharetoken, and identify any constraints on accessing the resource of the user account.

Upon generating the sharetoken, token service platform 208 may generate a provisioning link that can be transmitted to authorized device 204. The provisioning link includes a reference to provisioning platform 228 and/or to instructions that execute to provision partner user device 224. The reference may include a uniform resource locator (URL), remote procedure call (RPC), or to an interface (e.g., such as an application programming interface, or the like) that can trigger the provisioning process. Primary user device 204, transmits the provision link to notification platform 220. Notification platform 220 may include a distributed network of devices that facilitate communications between remote device. For example, notification platform may facilitate communications over short-messaging service (SMS), other direct messaging (e.g., instant messaging, or the like), email, and/or the like. Notification platform 220 may transmit the provisioning link to partner device 224 via an SMS push notification.

Partner user device 224 may access the provisioning link, which executes the partner application of the share-resource application. The share-resource application may be managed by application platform 216 which synchronizes the state of the share-resource application across devices, pushes updates, facilitates communication between the share-resource application and remote service providers (e.g., token services platform 208, account management platform 21, provisioning platform 228, and/or other platforms). Application platform 216 may also transmit notifications to user devices through the share-resource application executing on those devices by transmitting a communication identifying the devices (and/or share-access applications) that are to receive the notification to the notification platform 220. The notification platform 220 may then transmit the notifications to the devices identified by the communication through the share-access application executing on those devices. Application platform 216 may include one or more computing devices (e.g., desktop or laptop computers, mobile devices, servers, networks, other processing devices, combinations thereof, or the like) that manage the share-resource application.

When authorize user device 204 interacts with share-resource application, application platform 216 may analyze the interaction to determine if the interaction necessitates a corresponding update to be pushed to the share-resource application of partner user device 224. For example, if primary user device 204 provisions partner user device 224 with a particular sharetoken, then before partner user device 224 uses the sharetoken, primary user device 204 suspends the sharetoken, application platform 216 may detect the suspension and push an update to partner user device 224 to reflect the suspension.

Partner user device 224 may execute the provisioning link when it is received causing partner user device to execute the share-resource application. If the share-resource application is not already present in memory of partner user device 224, executing the provisioning link may cause partner user device 224 to download or otherwise acquire the share-resource application. The share-resource application may transmit an identifier of primary user device 204 to application platform 216 to link the shared-resource application executed by primary user device 204 with the shared-resource application executed by partner user device 224 Once linked, application platform 216 may synchronize the state of the shared-resource application executed by primary user device 204 with the state of the shared-resource application executed by partner user device 224.

Executing the provisioning link may also cause partner user device 224 to transmit a provisioning request to the device referenced by the provisioning link (e.g., provisioning platform 228). Provisioning platform 208 may include one or more computing devices (e.g., desktop or laptop computers, mobile devices, servers, networks, other processing devices, combinations thereof, or the like) configured to provision new devices with tokens and/or sharetokens received from token service platform 208. The request may include an identification of partner user device 224 and at least one of a reference primary user device 204 (e.g., a device identifier, and/or the like), a reference to the token of authorizer user device 204, a reference to the sharetoken, a reference to an identifier included in the provisioning link, or the like. The provisioning platform 228 transmits a provisioning request to token service platform 208, which in response, transmits the sharetoken that corresponds to the resource being shared to provisioning platform 228. Provisioning platform 228 then transmits the sharetoken to partner user device 224. Partner user device 224 may store the sharetoken may store the token in a wallet, in a share application (e.g., such as share-resource application 118 of FIG. 1), or otherwise in persistent (e.g., non-volatile) memory.

Once provisioned, partner user device 224 may initiate a transaction with an operator device and/or webserver using the sharetoken to access the shared resource. For example, the partner user device 224 may identify an object of acquisition for a particular quantity of resources. Partner user device 224 may transmit a representation of the sharetoken to the operator device and/or webserver and the operator device and/or webserver may execute the transaction by requesting the particular quantity of resources from the resource pool secured by account management platform 212. If the particular quantity of resources is less than or equal to an amount of resources that the sharetoken is authorized to access and less than or equal to the resource pool, then the transaction may be approved.

The resource-sharing configuration, an identification of any transactions initiated using the resources, the quantity of resources accessed, the operator device or user device with which the transaction was initiated, the webpage or webserver with which the transaction was initiated, the object or service subject to the transaction, combinations thereof, or the like may be stored in a transaction record when the sharetoken expires. The transaction record may be used in a machine-learning implementation to further refine the machine-learning models that generate the resource-sharing configuration and/or machine-learning models that process analytics associated with resource-sharing requests, or the like.

FIG. 2B illustrates an example diagram representing a process 200B for provisioning a device for shared access to a resource according to aspects of the present disclosure. Process 200B may begin when primary user device 204 transmits a request 232 to token service platform 208 to share access to a resource. In some instances, the request is generated by a share-resource application executing on primary user device 204. The share-resource application may be usable to initiate transactions using a token that corresponds to a resource as well as share limited access to that resource. The request may include an identification of the primary user device, access credentials that indicate that primary user device 204 is authorized to access the resource and/or that authenticate the request, an identification of partner user device 224, constraints on the shared access to the resource, combinations thereof, or the like. Token service platform 208 may process the request by determining that primary user device 204 is an authorized device (and/or by authenticating the request to ensure that the request is valid) and generating a sharetoken.

Token service platform transmits communication 236 to account management platform 212 with an indication that a sharetoken was generated. Communication 236 may include a representation of the sharetoken (e.g., an identification of the sharetoken, a secured version of the sharetoken that is encrypted or hashed, the sharetoken itself, combinations thereof, or the like), an identification of the resource to be shared, or an identification of the user account of primary user device 204 that corresponds to the resource being shared. Account management platform 212 may associate the sharetoken with the user account of primary user device 204. When a transaction is initiated with the sharetoken, account management platform may use the sharetoken to identify the resource for which the sharetoken grants limited access and the constraints that limit that access.

Token service platform 208 also transmit communication 240 to primary user device 240 with a provisioning link, that when executed, may cause a device to be provisioned with the sharetoken. Token service platform 208 may use the provisioning link in place of transmitting the sharetoken to primary user device 204 to avoid a chance in which the sharetoken is fraudulently obtained or inadvertently transmitted to the wrong device. For example, malware or other malicious code executing on primary user device 204, may obtain the sharetoken and/or cause the sharetoken to be transmitted to an authorized device. Since the sharetoken is linked to the user account of the primary user device 204, the sharetoken may be usable by the unauthorized device to access the resource of the primary user device 204. Using a provisioning link, token service platform may confirm that the recipient device is authenticated before transmitting the sharetoken to ensure that the sharetoken is not transmitted to or otherwise received by an authorized device.

Primary user device 204 may transmit transmission 244 partner user device 224 that includes the provisioning link. Transmission 244 may be over SMS, email, push notification, and/or any other communications channel. Upon being received and executed by partner user device 224, the provisioning link may cause partner user device 224 to be provisioned with the share-resource application (if not already stored in memory of partner user device 224) and/or the sharetoken. For example, executing the provisioning link causes partner user device to transmit request 248 to provisioning platform 228. Provisioning platform 228 determines if partner user device 224 has a share-resource application stored in local memory, and if not, causes the share-resource application to be downloaded by partner user device 224. Provisioning platform 224 may then transmit request 252 to token service platform 208 for sharetoken that corresponds to the provisioning link identifier and/or an identifier of partner user device 224. Token service platform may transmit response 256 to provisioning platform 228 that includes the sharetoken. In some instances, response 256 may also include metadata and/or other information associated with the authorization for accessing the resource. For example, response 256 may include an identification of any constraints and/or the like. Provisioning platform 228 transmits response 260 that includes the sharetoken, and if present, the metadata and/or other information included in response 256. Partner user device 224 may store the sharetoken in a wallet of the partner user device 224, in local memory of partner user device 224, and/or in the share-resource application of partner user device 224.

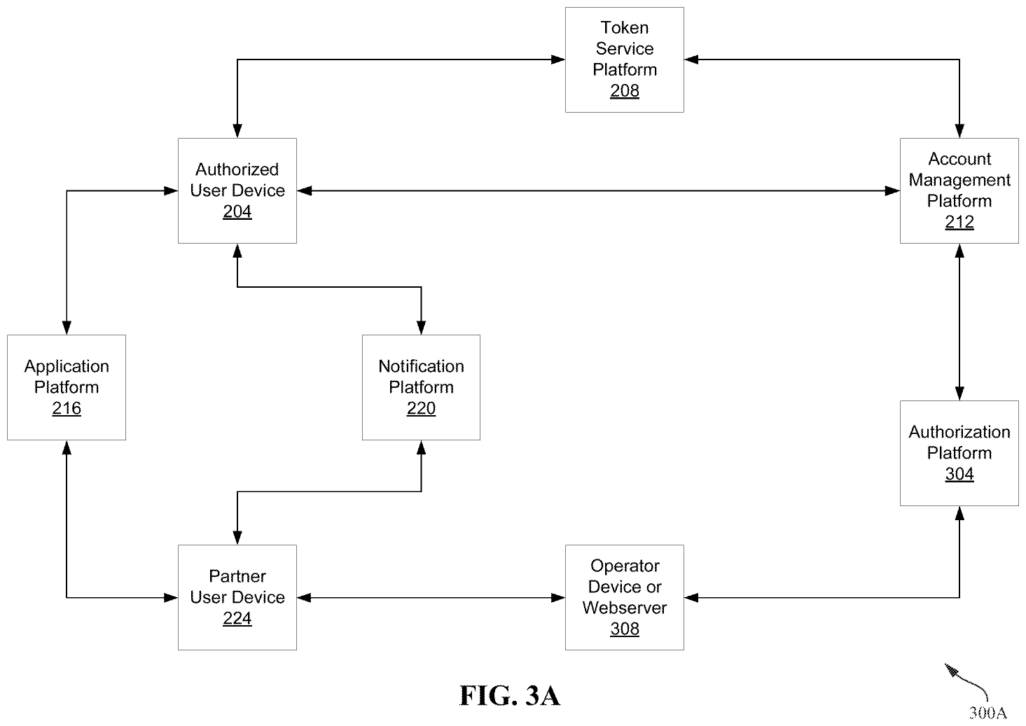

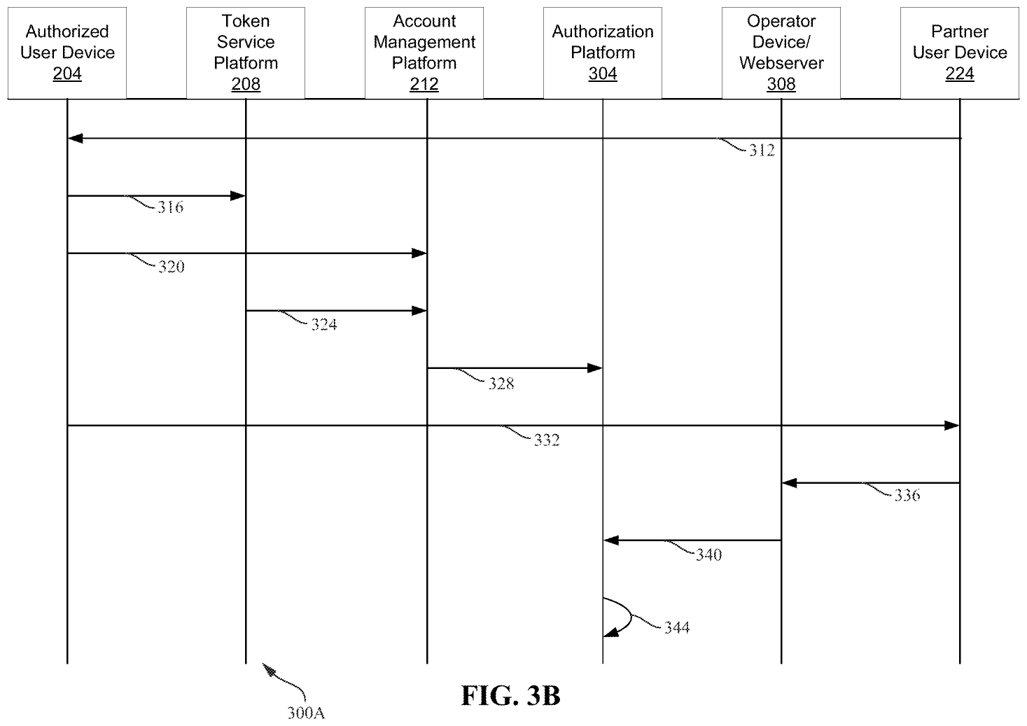

FIG. 3A illustrates an example block diagram representing a shared-access transaction system 300A according to aspects of the present disclosure. Shared-access transaction system 300A may include many of the platforms, devices, services, etc. as described in shared-access provisioning system 200A of FIG. 2A, as previously described. Shared-access transaction system 300A may facilitate a transaction between partner user device 224 and operator device or webserver 308 using a shared resource. In some instances, partner user device 224 may be provisioned with a sharetoken for future transactions with operator device and/or webservers (e.g., described in FIGS. 2A and 2B). When the constraints associated with the sharetoken are satisfied (e.g., the quantity of resources have been accessed, the quantity of transactions have been executed, a time interval expired, and/or the like), then the sharetoken may become deactivated (e.g., suspended). A suspended sharetoken may not be usable to initiate and/or execute transactions because account management platform may not recognize sharetoken as providing authorized access to the resource. After a sharetoken has been suspended, partner user device 224 may request subsequent access to the resource for a particular transaction, which may cause the sharetoken to become reactivated. Alternatively, while the sharetoken is still active (e.g., after provisioning as previously described), partner user device 224 may request authorization for each transaction involving the sharetoken until the constraints are satisfied and the sharetoken becomes suspended.

For example, partner user device 224 may request access to the resource owned or controlled by primary user device 204 to initiate or execute a transaction with operator device or webserver 308. Operator device may be a device of an operator (e.g., such as a POS device or the like). Webserver may include may operate a website configured to execute transactions or the like. In some examples, partner user device 224 may interact with operator device or webserver 308 for the acquisition of an object. Operator device or webserver 308 may request a quantity of resources in exchange for transferring or transmitting the object to partner user device 224 or a user thereof. Partner user device 224 may transmit a communication to primary user device 204 (via notification platform 220) requesting access to the resource. The communication may include an identification of the resource to be shared, a quantity of resources requested, an expected time of a transaction involving the resource, an identification of the object and/or service for which the resource is needed, an identification of operator device or webserver 308 that is to execute the transaction, an identification of a service provider of operator device or webserver 308, combinations thereof, or the like.

Primary user device 204 may determine whether to authorize partner user device 224 to access the resource. If authorized resource device 204 determines approve access to the resource, authorized resource device 204 may define a resource-sharing configuration (e.g., through user input, a machine-learning model as previously described, from a previous resource request, a combinations therefor, or the like). For example, primary user device 204 may approve the resource request without adjustment, approve the resource request subject one or more added constraints (e.g., limiting the quantity of resources that can be accessed, limiting the quantity of transactions that be initiated, limiting the time interval over which the quantity of resources is accessible, combinations therefor, or the like), deny the request, or the like. In some instances, if primary user device 204 adds constraints that alter request received from partner user device 224, primary user device may transmit the resource-sharing configuration to partner user device 224 to determine if partner user device 224 approves the resource-sharing request subject to the changes made by authorized device 204.

Primary user device 204 and token service platform 208 may facilitate a pre-authorization of a transaction with operator device or webserver 308 that includes the requested quantity of resources or less. For example, token service platform 208 may synchronize the requested quantity of resources with the resource pool secured by account management platform 212. Primary user device 204 may also transmit a transaction authorization communication to account management platform 212 that authorizes partner user device 224 to access the requested quantity of resources from the resource pool. Account management platform 212 may transmit a communication to authorization platform 304 that indicates that partner user device 224 is preauthorized to access the requested quantity of resources. Authorization platform may include one or more computing devices (e.g., desktop or laptop computers, mobile devices, servers, networks, other processing devices, combinations thereof, or the like) configured to approve or disapprove incoming transaction communications. Account management platform 212 establishes the pre-authorization with the authorization platform 304 to reduce the time needed to execute the transaction. For example, since the requested amount is pre-authorized, when the transaction occurs, authorization platform 304 can immediately approve the transaction without first having to communicate an authorization with account management platform 212.

Primary user device 204 may transmit a notification that pre-approval for the requested quantity of resources has been established. The notification may be transmitted via notification platform 220 as previously described. Upon receiving the notification, the sharetoken may be used to initiate the transaction operator device or webserver 308. For example, may transmit a representation of the sharetoken to operator device and/or webserver 308 through NFC, barcode, QR code, a wallet, and/or the like. Operator device and/or webserver 308 may then transmit the representation of the sharetoken along with the transaction information (e.g., identification of the object and/or service being acquired, quantity of resources included in the transaction, identification of partner user device 224, a timestamp, an identification of operator device or webserver 308, a transaction identifier, combinations thereof, or the like) to authorization platform 304. Authorization platform 304 may use the sharetoken and transaction information to determine if partner user device 224 is preauthorized for the requested quantity of resources. If so, the transaction may be approved. If partner user device 224 is not preauthorized, then authorization platform 304 may transmit the representation of the sharetoken and/or the transaction information to account management platform 212 to authorize the transaction. Account management platform 212 may transmit the determination as to whether partner user device 224 is authorized to authorization platform 304, which may then transmit the response back to operator device and/or webserver 308.

If the transaction is approved, the requested quantity of resources may be transferred from the resource pool to a service provider of operator device or webserver 308. Authorization platform 304 may transmit the transaction information to account management platform 212 (if authorization platform 304 has not already done so during the authorization) and an indication that the transaction was approved. Account management platform 212 may synchronize the transaction with the resource pool (e.g., removing the requested quantity of resources) and transmit the transaction information to primary user device 204. The share-resource application executing on primary user device 204 may notify a user of primary user device 204 with the transaction information (e.g., display at least a portion of the transaction information, etc.). Account management platform 212 may determine if the constraints of the sharetoken have been satisfied. If the constraints have been satisfied, the sharetoken may be suspended and account management platform 212 may facilitate a transaction to primary user device 204 and/or partner user device 224 that indicates the sharetoken has been suspended due to one or more of the constraints being satisfied. In some instances, account management platform 212 may identify the one or more constraints that have been satisfied and resulted in suspension of the token.

The aforementioned description of shared-access transaction system 300A may operate after partner user device 224 is provisioned with a sharetoken (e.g., subsequent to the operations described in FIG. 2A and/or 2B). In some instances, if partner user device 224 is not provisioned with a sharetoken, requesting access to the resource owned or controlled by primary user device 204 may trigger the provisioning of partner user device (according to the operations described in FIG. 2A and/or 2B). Alternatively, partner user device 224 may initiate a transaction with operator device or webserver 308 without a sharetoken. In that instance, primary user device 204 may transmit a single-use code (e.g., alphanumeric code, barcode, QR code, image, audio file, video file, and/or the like) that can be used to provide single-instance access to the resource. Primary user device 204 may receive the single-use code from token service provider 208 or primary user device 204 may generate the single-use code and transit the single-use code to token service provider 208. Token service provider 212 may transmit the single-use code to account management platform 212. Partner user device 224 may initiate the transaction by transmitting the single-use code instead of the sharetoken. Account management platform 212 and/or authorization platform 304 may authenticate the single-use code received from partner user device 224 (via operator device or webserver 308) with the single-use code received from token service platform 208 to authenticate the transaction.

In some examples, such as when partner user device 224 has been provisioned with a sharetoken that has not yet been suspended, (subsequent to the operations described in FIG. 2A and/or 2B), partner user device 224 may not request pre-authorization access to the resource. In those examples, instead of requesting access to the resource (which the sharetoken already enables), partner user device 224 may immediately initiate the transaction with operator device or webserver 308. Since the particular transaction may not be preauthorized, authorization platform 304 may communicate with account management platform 212 to authenticate the sharetoken and provide the requested access to the resource.

FIG. 3B illustrates an example diagram representing a process 300B for executing a transaction by a partner device with shared access to a resource according to aspects of the present disclosure. Process 300B may begin when partner user device 224 transmits communication 312 to primary user device 204 requesting preauthorized access to a resource owned or controlled by primary user device 204. In some instances, partner user device 224 may transmit communication 312 in response to an intention to initiate a transaction with operator device or webserver 308, initiating a transaction with operator device or webserver 308, a sharetoken being suspended, absence of a sharetoken (e.g., partner user device 224 not being provisioned), or the like. The communication may include an identification of the resource to be shared, a quantity of resources requested, an expected time of a transaction involving the resource, an identification of the object and/or service for which the resource is needed, an identification of operator device or webserver 308 that is to execute the transaction, an identification of a service provider of operator device or webserver 308, combinations thereof, or the like. Communication 312 may be transmitted directly to primary user device 204 or via notification platform 220.

In response, primary user device 204 may transmit communication 316 to token service platform 208 with an identification of the requested quantity of resource (and/or other details from communication 312). Primary user device 204 may also transmit communication 320 to account management platform 212 authorizing account management platform 212 to preauthorize the requested quantity of resources. In some instances, communication 316 and communication 320 may be transmitting in parallel (e.g., at approximately a same time). In other instances, communication 316 and communication 320 may be transmitted in series with communication 316 being transmitted before communication 320 (as shown) or vice versa. Token service platform 208 may transmit communication 324 to account management platform that includes a representation of the sharetoken provided to partner user device 224 (and that corresponds to the user account of primary user device 204 and the resource to be shared). Alternatively, if single-use code is being used in place of a sharetoken, then communication 324 may include a representation of the single-use code. Account management platform 212 may transmit communication 328 to authorization platform 304 to inform authorization platform 304 that partner user device 224 (or a transaction involving the sharetoken assigned to partner user device 224) is preauthorized for the requested quantity of resources.

Primary user device may then transmit communication 332 to partner user device (e.g., directly or through notification platform 220) indicating that the sharetoken is preauthorized for a transaction involving the requested quantity of resources. Partner user device 224 may then initiate a transaction (or continue the transaction if already initiated) with operator device or webserver 308 by transmitting communication 336. Communication 336 may include a representation of the sharetoken (or single-use code) as provided by NFC, barcode, QR code, a wallet, and/or the like. Operator device or webserver 308 may execute a transaction by transmitting communication 340 to authorization platform 304 that includes the representation of the sharetoken (or single-use code) and transaction information (e.g., identification of the object and/or service being acquired, quantity of resources included in the transaction, identification of partner user device 224, a timestamp, an identification of operator device or webserver 308, a transaction identifier, combinations thereof, or the like). Authorization platform 304 may determine, at 344, if the preauthorized quantity of resources is equal to or less than the requested quantity of resources of the transaction information. If so, then the transaction is approved.

In some instances, one or more additional communications may be transmitted. For example, a communication may be transmitted to operator device or webserver 308 and/or partner user device 224 indicating the transaction is approved. Alternatively, or additionally, a communication may be transmitted to account management platform 212 and/or primary user device 204 indicating the transaction was executed. The communication may include some or all of the transaction information provided to authorization platform 304.

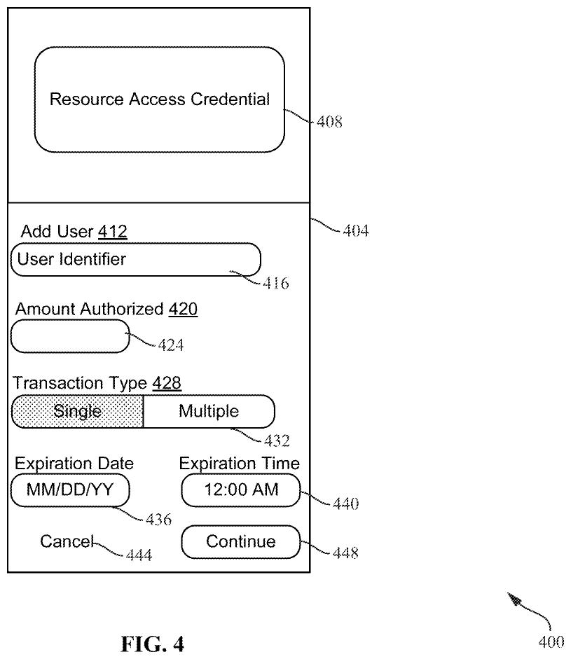

FIG. 4 illustrates an example user interface 400 for provisioning a device for shared access to a resource according to aspects of the present disclosure. User interface 400 may be an example representation of a share-resource application. User interface 404 may enable receiving user input for configuring shared access to a resource. For example, user input may be received selecting a representation of a resource access credentials (e.g., a depicted representation of a physical resource access credentials such as a credit card, or the like) that corresponds to a resource that is to be shared. Share-resource application may enable sharing of one or more different resources that are owned and/or controlled by a primary user with a partner user device. A representation of resource access credentials 408 that corresponds to the resource selected by a user for sharing may be displayed. Under the representation of resource access credentials 408 may include various user input elements that configure constraints on the resource access.

For example, add user 412 may enable user input of user identifier 416 corresponding to a partner user device for which shared access to the resource is to be enabled. Amount authorized 420 may enable user input of a quantity of resources 424 to share, which prevents the partner user device from accessing a greater quantity then quantity of resources 424 and causes the sharetoken to be suspended once the quantity of resources 424 is accessed. Transaction type 528 enables selection 432 of a single transaction or multiple transaction, which causes the sharetoken to be suspended after one transaction or after multiple transactions. In some instances, selection of multiple transactions may enable the partner user device initiate transactions until the quantity of resources 424 is accessed. When quantity of resources 424 is reached, the sharetoken may become suspended. In other instances, additional input may be received indicating a quantity that corresponds to multiple transactions, which may cause the sharetoken to become suspended once the quantity of transactions occurs. Expiration date 436 and expiration time 440 may restrict the time interval over which the sharetoken remains active. If the current time is greater than the expiration date 436 and/or expiration time 440, the sharetoken may be suspended regardless of whether partner user device initiated any transactions while the sharetoken was active.

User interface 404 may include one or more additional fields for controlling how the resulting token can be used to access to the resource. Examples of additional fields include, but are not limited to, a physical access type field, a categorical use field, a type of use field, combinations thereof, or the like. For example, a physical access type field may indicate a physical medium that may be used by the token generated to access the resource. The physical access types may include, but are not limited to swiping physical access credentials at a terminal (e.g., such as mobile pos device 110, operator 102, or the like), hand-keying a token identifier into the terminal, near field communication, tapping a physical access credentials, or the like. In one example, the physical access type field may be set to near field communication, which may restrict use of the resulting token to use in near field communications. The categorical use field may restrict the types of uses of the resulting token to particular categories of use (e.g., particular locations or operators, particular goods or services, types of locations or operators, types of goods or services, etc.). For example, the categorical use field may be set of entertainment limiting, which may limit use of the resulting token to operators, goods, and/or services classified as entertainment. The type of use may restrict how the token can be used, such as in person, online (e.g., through a webpage, webservice, etc.), etc.

Once user input corresponding to each of the user interface elements 412-440 is received, user input may be received selecting continue 448 to continue provisioning the partner user device corresponding user identifier 416. Alternatively, if at any time user input is received selecting cancel 444, then the process may terminate and/or return to a previous user interface (e.g., a user interface prior to user interface 404). If user input is received selecting continue 448, then the primary user device generates a configuration encapsulating the information of user interface elements 412-440 and transmits a request to share the resource corresponding to resource access credentials 408 to a token service provider as described in FIGS. 2A and 2B.

In some instances, user interface 404 may be configurable by a user, by a system managing the resource, the token service platform (e.g., such as token service platform 208, etc.), by a system that provided the resource to the primary user, and/or the like. For example, user input may be received that includes an indication of one or more fields (e.g., such as those shown, those described but not shown, and/or other fields) that are to be included in user interface 404. User input may be received indicating one or more fields to be added to or removed from fields that were previously selected to be included. In some instances, the configuration of user interface 404 may be based on a hierarchy of contribution such that the configuration of user interface 404 may be determined from multiple contributors based on the hierarchy assigned to each contributor.

For instance, user interface 404 may be associated with a set of possible fields that can be included in user interface 404. A particular system managing the resource (or that provided the resource to the primary user such as account management system 212, or the like) may select a first subset of the set of fields to be included in user interface 404. Each field in the first subset may include an indication as to whether the corresponding field is a mandatory or an optional field. A mandatory field may be required to be included in user interface 404 for primary users that have a resource managed (or that was provided by) the particular system. An optional field may be a field that can be included in user interface 404. Once the first subset of fields is defined, a second subset of fields may be defined from the first subset of fields. The second subset of fields may include those fields from the first subset of fields designated as optional. User input associated with the primary user may be received selecting one or more fields from the second subset of fields. A third subset of fields may be defined that includes the fields from the first subset of fields designated as mandatory and the one or more fields selected from the second subset of fields. User interface 404 may include the fields of the third subset of fields. The particular system can select a minimum quantity of fields that are to be included (e.g., those fields designated as mandatory) and select those fields for which the primary user can select.

The orientation of user interface 404 may be defined based on the fields to be included and/or user input. In some instances, the fields to be included in user interface 404 may be not fit. In those instances, user input may be received to increase or decrease the size of each field, select the position and/or orientation of each field within user interface 404, add a scroll bar (e.g., to add space for additional fields), add addition user interfaces (e.g., add a button, which when selected generates a new user interface with additional fields, etc.), combinations thereof, or the like.

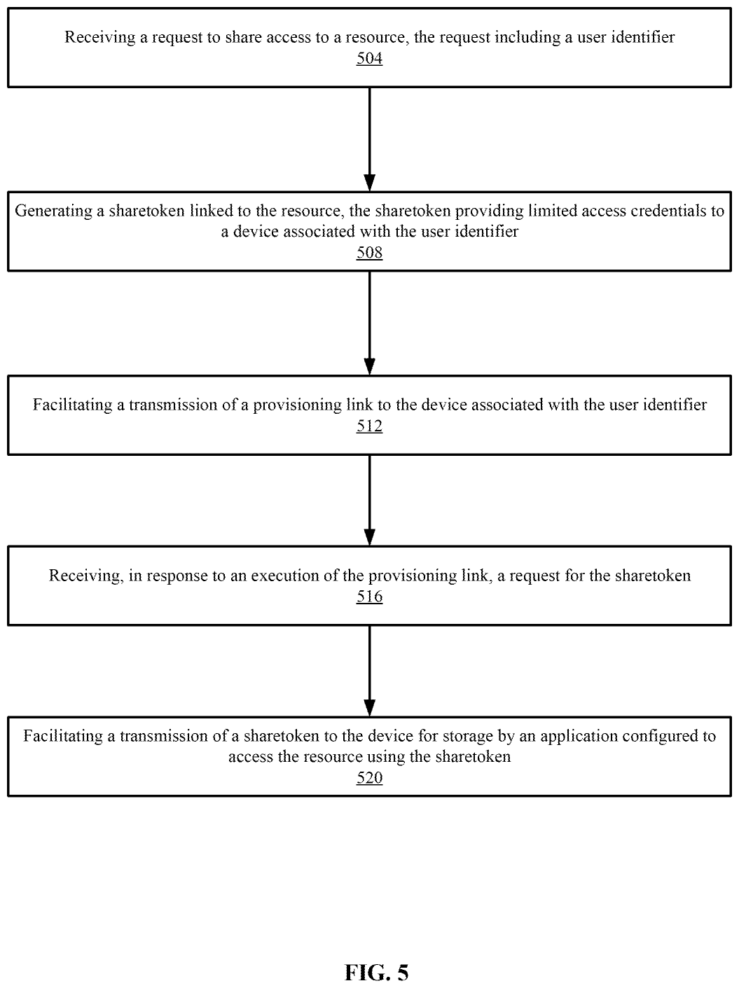

FIG. 5 illustrates a flowchart of an example process for a primary device provisioning a partner device for shared access to a resource according to aspects of the present disclosure. At block 504, a request to share access to a resource may be received. In some instances, the request may be received by a first computing device (e.g., a server, or the like). For example, the request may be received by a token service platform such as token service platform 212. The request may be received from a second computing device (e.g., an primary user device such as a mobile device, or the like) executing a share-resource application. The request may include a resource-sharing configuration that can include an identification of the resource to be shared, an identification of the second computing device and/or a user thereof, a primary access credentials of the second computing device or user thereof providing authorization to access and/or share the resource, an identification of any constraints on resource sharing (e.g., such as, but not limited to, a quantity of transactions that a third computing device for which sharing may be provide can initiate, a quantity of resources that are to be accessible, a time interval over which resource sharing is to occur, and/or the like), a device identifier corresponding to the third computing device for which shared access to the resource is requested, a user identifier corresponding to a user of the third computing device, and/or the like. In some instances, the third computing device may be mobile device (e.g., such as partner user device, or the like).

At block 508, a sharetoken linked to the resource may be generated. The sharetoken may be generated by the first computing device or another device. In some instances, the sharetoken may be generated in response to determining that the second computing device is authorized to access the resource and/or share the resource with the user identifier corresponding to the third computing device. The sharetoken may correspond to a secondary access credentials for the resource that is corresponds to, but is different from, the primary access credential. For example, the sharetoken may be linked to the primary access credentials and/or a token generated based on the primary access credential. When a transaction is initiated, the sharetoken may be used to identify the resource that the sharetoken provides access to and the constraints that limit that access.

At block 512, a transmission of a provisioning link to the device associated with the user identifier (i.e., the third computing device) may be facilitated. For example, the first computing device may facilitate a transmission to the third computing device by transmitting the provisioning link to the second computing device with instructions to forward the provisioning link to the third computing device (e.g., via push notifications). In some instances, the second computing device may transmit the provisioning link via a predetermined communication channel (e.g., SMS, email, direct messaging, through the share-resource application that is present on both the second computing device and the third computing device, and/or the like). Alternatively, or additionally, the first computing device may transmit the provisioning link to the third computing device directly.

At block 516, receiving a request for the sharetoken. The request for the sharetoken may be received from the third computing device in response to the third computing device executing the provisioning link. In some instances, the request for the sharetoken may be received by the first computing device directly from the third computing device. In other instances, the request for the sharetoken may be received by the first computing device from a provisioning platform. For example, executing the provisioning link may cause the third computing device to access a provisioning platform (e.g., provisioning platform 304, or the like) that may facilitate the provisioning of the third computing device. If the third computing device lacks the share-resource application, the provisioning platform may cause the share-resource application to be downloaded into local memory of the third computing device. If the third computing device includes the share-resource application, the provisioning platform may request the sharetoken from the first computing device (if not already stored in memory of the provisioning platform). The request may include the user identifier of the third computing device. The first device may compare the user identifier received from the provisioning platform (or from the third computing device directly) and compare it to the user identifier received from the second device in block 504 to authenticate the request.

At block 520, the sharetoken may be transmitted to the third computing device for storage by the share-resource application stored in memory of the third computing device. The first computing device may transmit the sharetoken to the provisioning platform, which then provisions the share-resource application of the third computing device with the sharetoken. Alternatively, if the provisioning platform is not present, the first computing device transmits the sharetoken directly to the third computing device.

The share-resource application may include a wallet that stores tokens and/or sharetokens that represent access credentials to resources. The share-resources application may use the tokens and/or sharetokens to access the resource. For example, the share-resource application may use the tokens and/or sharetokens to initiate and/or execute a transaction with an operator device such as a POS device. If the share-resource application does not include a wallet, tokens/or sharetokens may be stored in a wallet native to the device (e.g., such as Apple Wallet, Google Pay, and/or the like) and accessible to the share-resource application.

Once provisioned, the third computing device may initiate a transaction with an operator device (e.g., a POS device, or the like) or via a webserver through a webpage. The third computing device may use the sharetoken to access the resource via NFC, barcode, QR code, or the like. An authorization platform may authenticate the sharetoken, identify the resource, determine if the transaction is within the limits defined by the second computing device and, if so, approve the transaction.

In one example, a user that owns or controls a resource may intend to provide temporary access to a portion of the resource to another user. For example, a parent may intend to provide a portion of credit to a child so that the child can pay for dinner and a movie. The parent may indicate constraints on that access such as a quantity of resources that are authorized for sharing, a quantity of transactions that can be initiated, a time interval, or the like. The first computing device may facilitate the provisioning of child's mobile device (e.g., the third computing device) with a sharetoken that be used to access the resource. The sharetoken may include access credentials that are similar to, but different from, the access credentials of the parent to prevent continued access to the resource once the constraints are satisfied. Since access is both temporary and limited, when a predetermined quantity of resources is accessed by the other user, a time interval lapse, etc. access may be suspended to prevent excessive or unauthorized use of the resource. For example, the parent may authorize sharing up to $100 of credit for up to two transactions (e.g., dinner and a movie) for an evening. Once one or more of the constraints are satisfied, the sharetoken may be suspended to prevent to restrict further access to the resource. If the child attempts initiate transactions that exceed $100, more than two transactions, or a transaction on another day, the transactions may be denied. The sharetoken can be reactivated by the user (e.g., through the share-resource application linking the user's mobile device to the other user's mobile device) without having to reissue a new sharetoken. The user can provide on the demand, temporary, and/or limited access to the resource of the user.

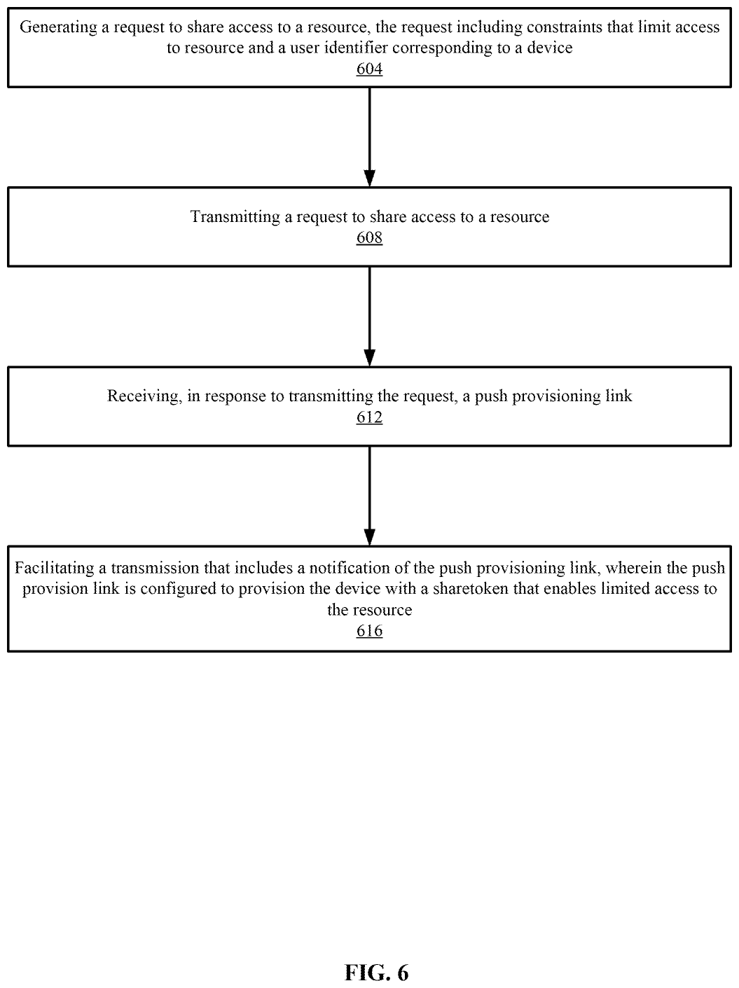

FIG. 6 illustrates a flowchart of an example process for a partner device being provisioned by a primary device for shared access to a resource according to aspects of the present disclosure. At block 604, a request to share access to a resource may be generated. The request may include constraints that limit access to resource and a user identifier corresponding to a device. For example, the request may include a resource-sharing configuration that defines the properties of the resource-sharing. Examples of properties that can be included in the resource-sharing configuration include, but are not limited to: an identification of the resource to be shared, an identification of the first computing device and/or the user thereof, a primary access credentials of the first computing device or user thereof providing authorization to access and/or share the resource, a device identifier corresponding to a second computing device for which shared access to the resource is requested, a user identifier corresponding to a user of the second computing device, an identification of any constraints on resource sharing (e.g., such as, but not limited to, a quantity of transactions that a second computing device can initiate, a quantity of resources that are to be accessible, a time interval over which resource sharing is to occur, and/or the like), combinations thereof, the like. In some instances, the second computing device may be mobile device (e.g., such as partner user device, or the like). In some instances, the resource-sharing configuration may be generated using machine-learning (e.g., automatically or semi-automatically generating the resource-sharing configuration).

At block 608, the request to share access to the resource may be transmitted. In some instances, the request may be transmitted by a share-resource application executing on a first computing device (e.g., a mobile device such as an primary user device, or the like) that is associated with a user that owns or controls a resource. The request may be transmitted to a token service platform such as token service platform 212.

At block 612, a push provisioning link may be received. The push provisioning link may be received by the first computing device in response to transmitting the request of block 604.

At block 616, a push notification may be transmitted to a device corresponding to the user identifier (e.g., the second device) that includes the push provisioning link. The push provisioning link may be configured to provision the device with a sharetoken that enables limited access to the resource. For example, the first computing device may transmit the push provisioning link via SMS, email, direct messaging, or the like to the second computing device through a notification platform (or directly). The second computing device may receive the push notification indicating the receipt of the push provisioning link. The second computing device may execute the push provisioning link, which may cause a provisioning request to be transmitted to a provisioning platform. The provisioning platform may facilitate downloading of a share-resource application by the second computing device (if not already present in local memory). The provisioning platform may also cause a sharetoken (e.g., a representation of an access credential), which enables the limited access to the resource, to be transferred to the second mobile device (e.g., from the token service platform, or the like). Alternatively, executing the provisioning link may cause a provisioning request to be transmitted to the token service platform which may provision the second computing device with the share-resource application and/or sharetoken.

Once provisioned, the second computing device may initiate a transaction with an operator device (e.g., a POS device, or the like) or via a webserver through a webpage. The third computing device may use the sharetoken to access the resource via NFC, barcode, QR code, or the like. An authorization platform may authenticate the sharetoken, identify the resource, determine if the transaction is within the limits defined by the second computing device and, if so, approve the transaction.

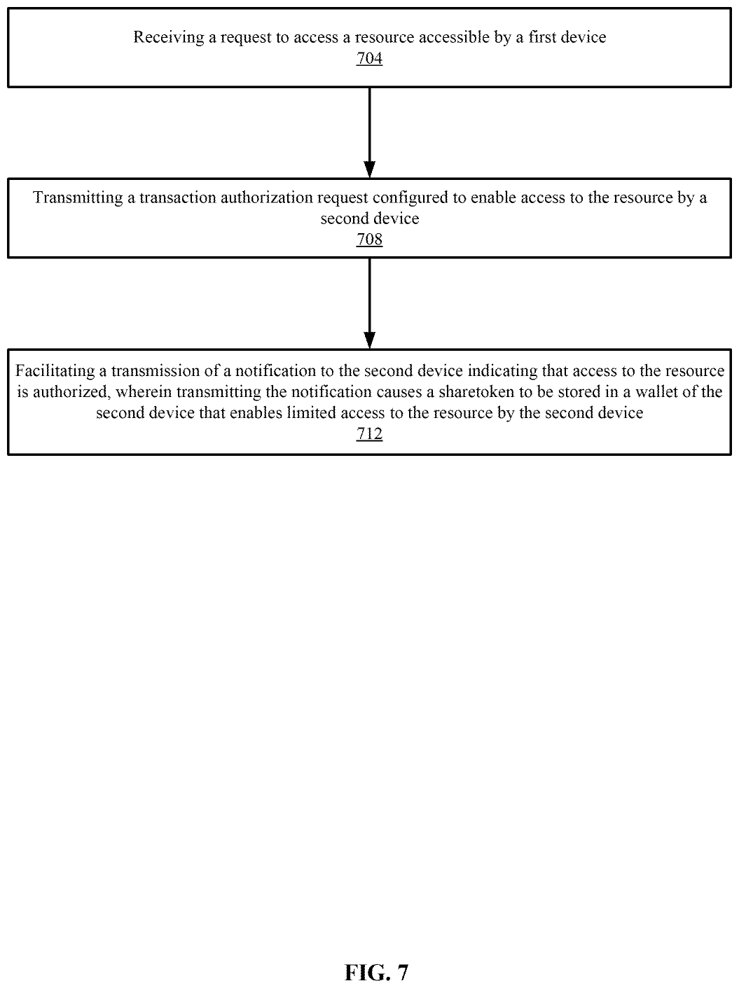

FIG. 7 illustrates a flowchart of an example process for executing a transaction by a partner device with shared access to a resource according to aspects of the present disclosure. At block 704, a request to access a resource accessible by a first device is received. The resource may be secured by a remote server that authenticates requests to access the resource and synchronizes transactions (e.g., ensuring the quantity of resources secured by the remote server are up-to-date, etc.). In some instances, the request may be received from the first device, but have originated from a second device. For example, the second device may transmit the request to access the resource owned and/or controlled by the first device. The second device may include a requested quantity of resources and/or other conditions (e.g., quantity of transactions, time interval over which access is being requested, or the like) in the request. In response to receiving the request from the second device, the first device may retransmit the request to a third device (e.g., a token service platform, or the like). The first device may define resource-sharing configuration that may be included in the retransmitted request (e.g., from the first device to the third device). The resource-sharing configuration can include an identification of the resource to be shared, an identification of the first computing device and/or a user thereof, a primary access credentials of the first computing device or user thereof providing authorization to access and/or share the resource, an identification of any constraints on resource sharing (e.g., such as, but not limited to, a quantity of transactions that the second computing device can initiate, a quantity of resources that are to be accessible if different from the requested quantity of resources, a time interval over which resource sharing is to occur, and/or the like), a device identifier corresponding to the second computing device for which shared access to the resource is requested, a user identifier corresponding to a user of the second computing device, and/or the like. In some instances, at least a portion of the resource-sharing configuration may be derived from the request received from the second device.

At block 708, the transaction authorization request configured to enable access to the resource by the second device may be transmitted. In some instances, in response to receiving the request from the first device, the request may first be authenticated (e.g., a determination as to whether access to the resource is from a source authorized to grant such access). The third device may then generate a sharetoken or, if a sharetoken is already generated, activate the sharetoken. The sharetoken may include a representation of an access credentials that enables limited access to the resource. The third device may then transmit the transaction authorization request to a remote device such as the device that secures access to the resource (e.g., an account management platform, or the like). The transaction authorization may synchronize the requested quantity of resources with the remote device. The remote device may transmit an identification of the requested quantity of resources to an authorization platform as a pre-authorization of the requested quantity of resources. This may enable a subsequent transaction that includes a quantity of resources that is less than or equal to the requested quantity of resources to be automatically approved without the remote device having to analyze and approve the transaction.

At block 712, a transmission of a notification to the second device indicating that access to the resource is authorized may be facilitated. For example, facilitating the transmission may involve the third device transmitting a communication to the first device that includes the indication that access to the resource is authorized. The first device may retransmit the indication to the second device (e.g., as a push notification via SMS, email, direct messaging, through a share-resource application, or the like). Transmitting the notification can cause the sharetoken to be stored in a wallet of the second device. The sharetoken may enable limited access to the resource based on the constraints defined in the resource-sharing configuration by the first device. In some instances, the second device may already have a sharetoken. If the sharetoken is suspended, then the notification may cause the sharetoken to become activated. If the sharetoken is not suspended, the sharetoken may be modified (e.g., the sharetoken itself or metadata associated with the sharetoken, or the like) to indicate that the requested access to the resource has been granted.

The second device may initiate a transaction with an operator device (e.g., a POS device, or the like) or via a webserver through a webpage using the sharetoken. For example, the second computing device may use the sharetoken to access the resource via NFC, barcode, QR code, or the like. If the transaction includes the requested quantity of resource for which the second device is preauthorized, then the transaction may be approved. If the transaction includes a request for a quantity of resources that is greater than the requested quantity of resources for which the second device is preauthorized, then the transaction may be passed to the remote device to determine if the quantity of resources requested by the transactions is within an quantity of resources authorized by the first device (in the resource-sharing configuration). If so, then the remote device may approve the transaction. If not, then the remote device may transmit an indication that the transaction is denied.

FIG. 8 shows a computing system architecture including various components in electrical communication with each other using a connection in accordance with various examples. FIG. 8 illustrates a computing system architecture 800 including various components in electrical communication with each other using a connection 806, such as a bus, in accordance with some implementations. Example system architecture 800 includes a processing unit (CPU or processor) 804 and a system connection 806 that couples various system components including the system memory 820, such as ROM 818 and RAM 816, to the processor 804. The system architecture 800 can include a cache 802 of high-speed memory connected directly with, in close proximity to, or integrated as part of the processor 804. The system architecture 800 can copy data from the memory 820 and/or the storage device 808 to the cache 802 for quick access by the processor 804. In this way, the cache can provide a performance boost that avoids processor 804 delays while waiting for data. These and other modules can control or be configured to control the processor 804 to perform various actions.

Other system memory 820 may be available for use as well. The memory 820 can include multiple different types of memory with different performance characteristics. The processor 804 can include any general purpose processor and a hardware or software service, such as service 1 810, service 2 812, and service 3 814 stored in storage device 808, configured to control the processor 804 as well as a special-purpose processor where software instructions are incorporated into the actual processor design. The processor 804 may be a completely self-contained computing system, containing multiple cores or processors, a bus, memory controller, cache, etc. A multi-core processor may be symmetric or asymmetric.

To enable user interaction with the computing system architecture 800, an input device 822 can represent any number of input mechanisms, such as a microphone for speech, a touch-sensitive screen for gesture or graphical input, keyboard, mouse, motion input, speech and so forth. An output device 824 can also be one or more of a number of output mechanisms known to those of skill in the art. In some instances, multimodal systems can enable a user to provide multiple types of input to communicate with the computing system architecture 800. The communications interface 826 can generally govern and manage the user input and system output. There is no restriction on operating on any particular hardware arrangement and therefore the basic features here may easily be substituted for improved hardware or firmware arrangements as they are developed.

Storage device 808 is a non-volatile memory and can be a hard disk or other types of computer readable media which can store data that are accessible by a computer, such as magnetic cassettes, flash memory cards, solid state memory devices, digital versatile disks, cartridges, RAMs 816, ROM 818, and hybrids thereof.

The storage device 808 can include services 810, 812, 814 for controlling the processor 804. Other hardware or software modules are contemplated. The storage device 808 can be connected to the system connection 806. In one aspect, a hardware module that performs a particular function can include the software component stored in a computer-readable medium in connection with the necessary hardware components, such as the processor 804, connection 806, output device 824, and so forth, to carry out the function.

The disclosed system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor. The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0) modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system may operate as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, a smartphone, a processor, a telephone, a web appliance, a network router, switch or bridge, or any system capable of executing a set of instructions (sequential or otherwise) that specify actions to be taken by that system.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Examples of machine-readable storage media, machine-readable media, or computer-readable (storage) media may include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

While the machine-readable medium or machine-readable storage medium is described, by way of example, to be a single medium, the terms “computer readable medium”, “computer readable storage medium”, “machine-readable medium” and “machine-readable storage medium” should be taken to include a single medium or multiple media (e.g., a centralized or distributed database, and/or associated caches and servers) that store the one or more sets of instructions. The terms “computer readable medium”, “computer readable storage medium”, “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included (e.g. in FIGS. 6-8). A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
receiving, at a first computing device, a request to share access to a resource, wherein access to the resource is to be shared with a second computing device, and wherein the request includes a user identifier associated with the second computing device, and one or more constraints restricting use of the resource by the second computing device;
generating a sharetoken that is linked to the resource, the sharetoken representing a limited access credential that provides limited access to the resource;
facilitating transmission of a provisioning link to the second computing device based on the user identifier, wherein the provisioning link is transmitted through an application stored on the second computing device;
receiving a request for the sharetoken, wherein the request for the sharetoken is received after execution of the provisioning link;
transmitting the sharetoken to the second computing device, wherein the sharetoken is stored in a wallet managed by the application of the second computing device;
detecting, by the first computing device, that at least one of the one or more constraints is satisfied; and
suspending, in response to detecting that the at least one of the one or more constraints is satisfied, wherein suspending the sharetoken prevents the second computing device from initiating a transaction that uses the sharetoken to access the resource.

2. (canceled)

3. The method of claim 1, wherein a first constraint of the one or more constrains limits the use of the sharetoken to a particular location.

4. The method of claim 1, wherein access to the resource is suspended after the second computing device accesses the resource a quantity of times.

5. The method of claim 1, wherein access to the resource is suspended after the second computing device accesses a quantity of the resource.

6. (canceled)

7. The method of claim 1, wherein the sharetoken provides access to the resource through near-field communication.

8. The method of claim 1, further comprising:
receiving a subsequent request to share access to the resource, the subsequent request including a user identifier;
determining that the sharetoken has been suspended; and
activating the sharetoken, wherein activating the sharetoken provides limited access to the resource by the second computing device.

9. (canceled)

10. A system comprising_:
one or more processors; and
a non-transitory computer-readable medium storing instructions that when executed by the one or more processors, cause the one or more processors to perform operations including:
receiving, at a first computing device, a request to share access to a resource, wherein access to the resource is to be shared with a second computing device, and wherein the request includes a user identifier associated with the second computing device, and one or more constraints restricting use of the resource by the second computing device;
generating a sharetoken that is linked to the resource, the sharetoken representing a limited access credential that provides limited access to the resource;
facilitating transmission of a provisioning link to the second computing device based on the user identifier, wherein the provisioning link is transmitted through an application stored on the second computing device;
receiving a request for the sharetoken, wherein the request for the sharetoken is received after execution of the provisioning link;
transmitting the sharetoken to the second computing device, wherein the sharetoken is stored in a wallet managed by the application of the second computing device;
detecting, by the first computing device, that at least one of the one or more constraints is satisfied; and
suspending, in response to detecting that the at least one of the one or more constraints is satisfied, wherein suspending the sharetoken prevents the second computing device from initiating a transaction that uses the sharetoken to access the resource.

11. A non-transitory computer-readable medium storing instructions that when executed by one or more processors, cause the one or more processors to perform operations including:
receiving, at a first computing device, a request to share access to a resource, wherein access to the resource is to be shared with a second computing device, and wherein the request includes a user identifier associated with the second computing device, and one or more constraints restricting use of the resource by the second computing device;
generating a sharetoken that is linked to the resource, the sharetoken representing a limited access credential that provides limited access to the resource;
facilitating transmission of a provisioning link to the second computing device based on the user identifier, wherein the provisioning link is transmitted through an application stored on the second computing device;
receiving a request for the sharetoken, wherein the request for the sharetoken is received after execution of the provisioning link;
transmitting the sharetoken to the second computing device, wherein the sharetoken is stored in a wallet managed by the application of the second computing device;
detecting, by the first computing device, that at least one of the one or more constraints is satisfied; and
suspending, in response to detecting that the at least one of the one or more constraints is satisfied, wherein suspending the sharetoken prevents the second computing device from initiating a transaction that uses the sharetoken to access the resource.

12. The system of claim 10, wherein a first constraint of the one or more constrains limits the use of the sharetoken to a particular location.

13. The system of claim 10, wherein access to the resource is suspended after the second computing device accesses the resource a quantity of times.

14. The system of claim 10, wherein access to the resource is suspended after the second computing device accesses a quantity of the resource.

15. (canceled)

16. The system of claim 10, wherein the sharetoken provides access to the resource through near-field communication.

17. The system of claim 10, further comprising:
receiving a subsequent request to share access to the resource, the subsequent request including a user identifier;
determining that the sharetoken has been suspended; and
activating the sharetoken, wherein activating the sharetoken provides limited access to the resource by the second computing device.

18. The non-transitory computer-readable medium of claim 11, wherein a first constraint of the one or more constrains limits the use of the sharetoken to a particular location.

19. The non-transitory computer-readable medium of claim 11, wherein access to the resource is suspended after the second computing device accesses the resource a quantity of times.

20. The non-transitory computer-readable medium of claim 11, wherein access to the resource is suspended after the second computing device accesses a quantity of the resource.

21. (canceled)

22. The non-transitory computer-readable medium of claim 11, wherein the sharetoken provides access to the resource through near-field communication.

23. The method of claim 1, wherein a first constraint of the one or more constraints enables use of the sharetoken by terminal devices that are in physical proximity to the second computing device.

24. The system of claim 10, wherein a first constraint of the one or more constraints enables use of the sharetoken by terminal devices that are in physical proximity to the second computing device.

25. The non-transitory computer-readable medium of claim 11, wherein a first constraint of the one or more constraints enables use of the sharetoken by terminal devices that are in physical proximity to the second computing device.
